(19) United States
(12) Patent Application Publication
(10) Pub. No.: US 2022/0391785 A1
(43) Pub. Date: Dec. 8, 2022

(54) CONTINUOUS DELIVERY SYSTEMS

(71) Applicant: AT&T Intellectual Property I, L.P., Atlanta, GA (US)

(72) Inventors: Robert T. Moton, JR., Alpharetta, GA (US); Adrianne Binh Luu, Atlanta, GA (US); James Pratt, Round Rock, TX (US); Barrett Kreiner, Woodstock, GA (US); Walter Cooper Chastain, Atlanta, GA (US); Ari Craine, Marietta, GA (US); Robert Koch, Peachtree Corners, GA (US)

(21) Appl. No.: 17/338,663

(22) Filed: Jun. 3, 2021

(51) Int. Cl. G06Q 10/04; G06Q 10/06; G06Q 10/08; G06Q 10/02; G06Q 30/02; G01C 21/34

(52) U.S. Cl. CPC G06Q 10/047; G06Q 10/06315; G06Q 10/08355; G06Q 10/06312; G06Q 10/087; G06Q 10/0836; G06Q 10/02; G06Q 30/0205; G01C 21/3407

(57) ABSTRACT

A processing system including at least one processor may identify a demand for a plurality of types of items in an area that is assigned to a delivery vehicle, determine a first route to traverse the area to maximize a fulfillment of the demand, identify items from the plurality of types of items to load onto the delivery vehicle, and dispatch the delivery vehicle on a first trip over the first route, the delivery vehicle carrying the items that are identified.

The present disclosure relates generally to shipping and delivery networks and more particularly to methods, computer-readable media, and apparatuses for determining a first route for dispatching a delivery vehicle on a first trip to traverse an area to maximize a fulfillment of a demand for a plurality of types of items in the area.

### BACKGROUND

Current delivery systems may consider a set of predefined delivery orders comprising purchased items to be delivered from a distribution center to a number of delivery locations, e.g., on a given day and via one or more trips using one or more delivery vehicles. A dispatcher who is familiar with a delivery area containing the delivery locations may manually set a sequence of deliveries for a given delivery vehicle. Generally, the items to be delivered, and the stops to be made, are fixed once the delivery vehicle is loaded and departs from the distribution center.

### SUMMARY

In one example, the present disclosure describes a method, non-transitory computer-readable medium, and apparatus for determining a first route for dispatching a delivery vehicle on a first trip to traverse an area to maximize a fulfillment of a demand for a plurality of types of items in the area. For instance, in one example, a processing system including at least one processor may identify a demand for a plurality of types of items in an area that is assigned to a delivery vehicle, determine a first route to traverse the area to maximize a fulfillment of the demand, identify items from the plurality of types of items to load onto the delivery vehicle, and dispatch the delivery vehicle on a first trip over the first route, the delivery vehicle carrying the items that are identified.

### BRIEF DESCRIPTION OF THE DRAWINGS

The teachings of the present disclosure can be readily understood by considering the following detailed description in conjunction with the accompanying drawings, in which:

FIG. 1 illustrates an example system comprising one or more communication networks related to the present disclosure;

FIG. 2 illustrates an example delivery area with a delivery route, in accordance with the present disclosure;

FIG. 3 illustrates a flowchart of an example method for determining a first route for dispatching a delivery vehicle on a first trip to traverse an area to maximize a fulfillment of a demand for a plurality of types of items in the area; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure enable a continuous delivery system to provide quick delivery of items to a location that are already in transit in a general direction of the location. For instance, the present disclosure may provide for delivery of grocery items, household items, or other items to a home location, to a business, or to a publicly accessible place, such as a sidewalk, a park, and so forth. The present disclosure may also relate to delivery of items in other scenarios, such as delivery of food, drinks, souvenirs, or other items in a theme park, stadium, or other entertainment or travel destinations, or the like.

One or more delivery locations, such as homes, may possess “smart” appliances having sensors and network communication components that may collect a list of items that may be needed in the home (or other locations). For instance, a smart refrigerator may detect that milk is running out, a printer may detect that ink is running low or has run out, a user may speak a command to a virtual assistant to “add peanut butter to the list,” etc. A virtual assistant or other applications may maintain a list of items (e.g., a wish list, an online “shopping cart,” etc.) for when such items may be available again for purchase. Similarly, users may manually indicate an interest in items by adding items to online shopping carts, wish lists, or the like, via one or more user devices, such as user's mobile smartphones, home computers, laptop computers, tablet computing devices, wearable computing devices, etc. Although such a list of desired items can be assembled in a number of different ways, the user must often initiate an order for purchasing such items to be delivered to the user's home. It may also be impractical to initiate an order if the number of items on the list is not sufficiently large or the list is deemed to be incomplete by the user, e.g., the user could use more eggs but this single item may not be sufficiently urgent for the user to initiate an order for eggs to be delivered to the user's home or to travel to a physical store to acquire this single item.

In one embodiment, there may exist one or more delivery vehicles (e.g., in one example, autonomous delivery vehicles) that are managed by a distribution system, or “delivery system,” that maintains and manages routes for each delivery vehicle. In one example, the delivery system may also maintain and manage the inventory for each delivery vehicle. In one example, each delivery vehicle may be assigned a delivery area, defined as an area from which the delivery vehicle may receive and fulfill delivery orders when it is in operation. In one example, the delivery area may be represented by a set of geographic coordinates defining corners of the bounds of the delivery area, or ranges of coordinates defining edges of the area. In one example, the delivery area may be initially established based upon homes, businesses, or other locations that have been most delivered to in the past, or which may be most likely to be interested in receiving deliveries based on demographics, wish lists, or other factors. Likewise, a starter delivery route, or initial delivery route may be established, and may represent a route that most efficiently traverses the area (e.g., avoiding congested locations, reaching or coming close to a large number of people in the area, having stopping locations with ample parking spots to support easy pickup, etc.), or the route was previously traversed based on numerous prior deliveries made. For instance, a location from which prior orders have been received may be on the delivery route, but other locations in the delivery area from which orders have not been received may be omitted from the delivery route.

The delivery system may provide an application (“app”) that may be installed and operate on users' computing devices. In one example, the app may comprise a “skill” that may be added to a virtual assistant application, or the like. In any case, via their respective apps, users may opt-in to being included in the delivery service provided by the delivery system of the present disclosure. By opting-in, the users' apps/computing devices may share device locations and/or user locations with the delivery system. The delivery system may therefore identify, for each user device and/or user, whether the user device and/or user is located within the delivery area of a particular delivery vehicle. If so, the delivery system may send an alert to user devices within the delivery area to notify users that the delivery vehicle will be operating within the zone, to indicate an expected time of arrival at one or more locations within the zone, to indicate items available on the delivery vehicle, and so forth.

A user device, e.g., an app thereon, may compare a list of needed items to the inventory of the delivery vehicle to identify which items may be obtained from the delivery vehicle. The user device may then request that the delivery vehicle delivery one or more items that may already be en route, thereby enabling a close to instantaneous delivery as possible, depending upon how close the delivery vehicle is to the location when the order is received. In one example, the order may be sent from the user device to the delivery system (e.g., delivery system server(s)), which may transmit an instruction to the delivery vehicle to make a stop at or near the location. One aspect of the present disclosure is that the items on the delivery vehicle were not loaded into the delivery vehicle in response to any specific prior user requests before starting on its route. In other words, in one embodiment the items loaded onto the delivery vehicle were chosen by the delivery system and not in direct response to any prior user requests.

In another example, once the delivery vehicle is en route the order may be sent directly to the delivery vehicle, e.g., via peer-to-peer and/or short range wireless communications, e.g., Institute of Electrical and Electronics Engineers (IEEE) 802.11 based communications (e.g., Wi-Fi, Wi-Fi Direct), IEEE 802.15 based communications (e.g., Bluetooth, Bluetooth Low Energy (BLE), and/or ZigBee communications), LTE Direct, Dedicated Short Range Communications (DSRC), e.g., in the 5.9 MHz band, or the like. For instance, the delivery vehicle may confirm that it has milk, eggs, and bread that are in the order, and may reserve the items so that the items are not taken by or given away to others, may schedule a stop or add a stop to the route, and/or may modify the route to include a stop at the user's location, and so forth.

Alternatively, or in addition, a user may receive the notification via the user's computing device and may peruse a list of items on board the delivery vehicle that is en route. The user may then manually select one or more items for placing an order, which may be transmitted to the delivery vehicle directly and/or via the delivery system server(s). In one example, a virtual assistant or another app may determine what dishes are possible to make with ingredients on-hand, and which ingredients may be missing, but which can be procured from the delivery vehicle. In such case, the app may suggest dishes to the user and indicate that the dish can be made with just one or several ingredients on the delivery vehicle (possibly combined with other ingredients that are already on hand at home). Similar to the above, a stop for the order may be noted along the route, and/or the route may be modified to accommodate a stop off the route, etc.

It should be noted that a delivery may not necessarily be made to a home, business, or other locations having a permanent or relatively permanent association with a user, but may be made to a mobile user who is within the delivery area or who may travel into the delivery area. For instance, a delivery may be made to a pedestrian, a user in a vehicle, etc. For example, the delivery location may be a point on the route that is closest to the user's current location or a location where the user is scheduled or otherwise predicted to be at a certain time before the delivery vehicle arrives, etc. In one example, the delivery vehicle may be enabled to deviate from a planned route up to a certain distance off-route and/or a certain predicted time off-route to accommodate a delivery. Otherwise, an instruction may be transmitted to the user to meet the delivery vehicle at a selected location along the route (or a selected location that is not further than the maximum allowed deviation off of the route).

In one example, before or when the delivery vehicle arrives at the location designed for the delivery to the user, the items may be sorted onboard and placed in a delivery pod. The delivery pod may be locked and a digital key may be sent to the user for receiving at the user's computing device. In one example, a delivery from a road to a final placement at a location, such as on the porch of a home, may be made via aerial or surface operating autonomous vehicles, such as may be carried on board the larger delivery vehicle.

In one example, the inventory loaded on the delivery vehicle at a distribution center before embarking on a trip along the planned route may be based upon predicted needs of existing users within the delivery area and/or past orders from within the delivery area. On a subsequent trip through the area, the delivery vehicle may be loaded with the same or a different mix of items in the inventory and may follow the same route or a different route. An alert may also be sent to users and/or the users' computing devices within the delivery area to notify that the delivery vehicle is scheduled to be in the delivery area, to inform the route and/or the expected times to be at different locations along the route, and so forth. In one example, the delivery vehicle or the delivery system server(s) may promote one or more items, such as a new book by an author of another book that the user has previously read. The opportunity for a nearly instant delivery may be announced via a virtual assistant or another app on a user's computing device, and may be offered for a fixed location or any number of possible locations that may be available to a mobile user who happens to be in the delivery area.

For orders/deliveries that may cause the delivery vehicle to modify the route for a trip, or deviate from the scheduled route, the modification and/or deviation may be used to modify the scheduled delivery route for one or more subsequent trips. Thus, the distribution system may modify the scheduled delivery route on an ongoing basis to create a most efficient path through the delivery area, e.g., to maximize a fulfillment of a demand for a plurality of types of items in an area, which may be based upon predicted users and their needs and/or interests, or the like, and/or based upon predicted orders (e.g., predicted based upon past orders within the area and/or other factors).

In one example, a delivery area, or delivery areas may also be modified over time based on data collected on user locations, locations from which orders are received, or other factors. For instance, if the delivery system and/or a delivery vehicle determines that most orders and/or deliveries are in a lower portion of a delivery area, the delivery area may be shrunk to include only that portion for improved energy efficiency and faster delivery times to maximize a fulfillment of a demand for a plurality of types of items in an area (e.g., to move as much inventory as possible in a given period of time, or to move as much value of inventory as possible in the given period of time). In one example, delivery vehicles may cooperate, or the delivery system server(s) may coordinate to adjust area boundaries. For instance, if a first area has many deliveries in a northwest corner and only a handful of deliveries in a southeast corner, and the southeast corner also happens to be close to many deliveries near an edge of an adjacent area, the southeast corner of the first area may be reassigned to the adjacent area.

Through ongoing refinement, the determination of delivery areas and the optimal routes through such delivery areas may be learned in order to establish a continuous delivery environment, where each vehicle operates primarily within its assigned delivery area, and may be resupplied by returning to a distribution center, or from a resupply drone or other helper vehicle(s). In one example, the delivery system server(s) or a delivery vehicle may present variable options for delivery to various users. For instance, if there are more actual orders from users than can actually be fulfilled from the current inventory of a delivery vehicle, there may be a “get it in 5 minutes” price and a “get it in 2 hours price.” In one example, in a competitive environment, there may be multiple delivery systems having different delivery vehicles operating in the area (which may have different routes and/or different delivery area boundaries). In such case, a user may receive multiple offers or notifications of inventory items from various delivery vehicles, and may make a selection from among multiple available opportunities. Alternatively, a virtual assistant or another app may make such a selection on behalf of the user, e.g., based upon a list of needed items, an acceptable price point for each needed item, a shopping cart and/or shopping list, etc.

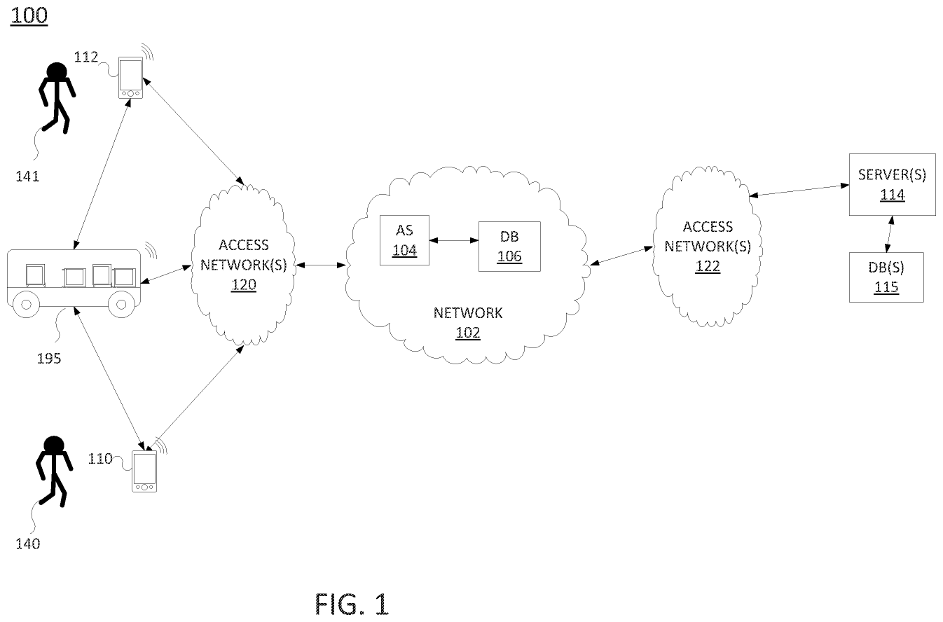

It should be noted that in accordance with the present disclosure, a delivery vehicle is not loaded based upon prior orders, but on prospective needs and prospective order. Thus, a route is not based upon known delivery locations for existing orders, but a prediction of the most likely locations of users who may place orders for and during a particular trip of the delivery vehicle on a route through the delivery area. A lap or trip may be a traversal of a route through the delivery area from a time of leaving a dispatch center to a time of returning to the dispatch center to resupply or refuel, etc. Thus, the delivery system server(s) and/or a delivery vehicle may learn over time where to be and when. One business may have many users who frequently place order during lunch hours, and so it may be that an optimized route includes a path through or near the business location between 12:30 pm and 1:30 pm, while a residential neighborhood may be the source of many orders after work hours, and thus it may be the case that a route for a different trip in the evening comprises a path that crosses through the neighborhood, but which may exclude traversing a part of the delivery area near the business location. Similarly, a route may change for a particular trip when large gatherings of users are detected, such as for large sporting or entertainment events, and so forth. These and other aspects of the present disclosure are described in greater detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102 (e.g., a telecommunication network of a telecommunication service provider). The network 102 may be in communication with one or more access networks 120 and 122, and the Internet (not shown). In one example, network 102 may combine core network components of a cellular network with components of a triple play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video-on-demand (VoD) server, and so forth. For ease of illustration, various additional elements of network 102 are omitted from FIG. 1.

In one example, the access networks 120 and 122 may comprise Digital Subscriber Line (DSL) networks, public switched telephone network (PSTN) access networks, broadband cable access networks, Local Area Networks (LANs), wireless access networks (e.g., an Institute of Electrical and Electronics Engineers (IEEE) 802.11/Wi-Fi network and the like), cellular access networks, 3^{rd} party networks, and the like. For example, the operator of network 102 may provide a broadband Internet access service, or any other types of telecommunication service to subscribers via access networks 120 and 122. In one example, the access networks 120 and 122 may comprise different types of access networks, may comprise the same type of access network, or some access networks may be the same type of access network and other may be different types of access networks. In one example, the network 102 may be operated by a telecommunication network service provider. The network 102 and the access networks 120 and 122 may be operated by different service providers, the same service provider or a combination thereof, or may be operated by entities having core businesses that are not related to telecommunications services, e.g., corporate, governmental, or educational institution LANs, and the like. In one example, one or more of access network(s) 122 may be associated with a restaurant 190.

In one example, the access network 120 may be in communication with one or more devices 110 and 112. Similarly, access network 122 may be in communication with one or more devices, e.g., servers 114 and databases 115, etc. Access networks 120 and 122 may transmit and receive communications between devices 110 and 112, servers 114, delivery vehicle 195, application server (AS) 104 and/or other components of network 102, devices reachable via the Internet in general, and so forth. In one example, each of the devices 110 and 112 may comprise any single device or combination of devices that may comprise an endpoint device, e.g., a client device. For example, the devices 110 and 112 may each comprise a mobile device, a cellular smart phone, a laptop, a tablet computer, a desktop computer, a wearable computing device, an application server, a bank or cluster of such devices, an internet of things (IoT) device, such as a smart refrigerator, a smart home hub, and the like.

In one example, device 110 may be associated with a user 140 and device 112 may be associated with another user 141, e.g., users of a continuous delivery service. For instance, device 110 and/or device 112 may have an application (app) installed thereon, which may facilitate receiving notifications of delivery vehicle routes, timing, and inventories, placing of orders, and so forth. In one example, devices 110 and 112 may store shopping lists, wish lists, or the like, as described herein. In one example, either or both of devices 110 or 112 may include one or more radio frequency (RF) transceivers (as well as antenna(s), and/or other components) for cellular communications and/or for non-cellular wireless communications, such as for IEEE 802.11 based communications, IEEE 802.15 based communications, and so forth.

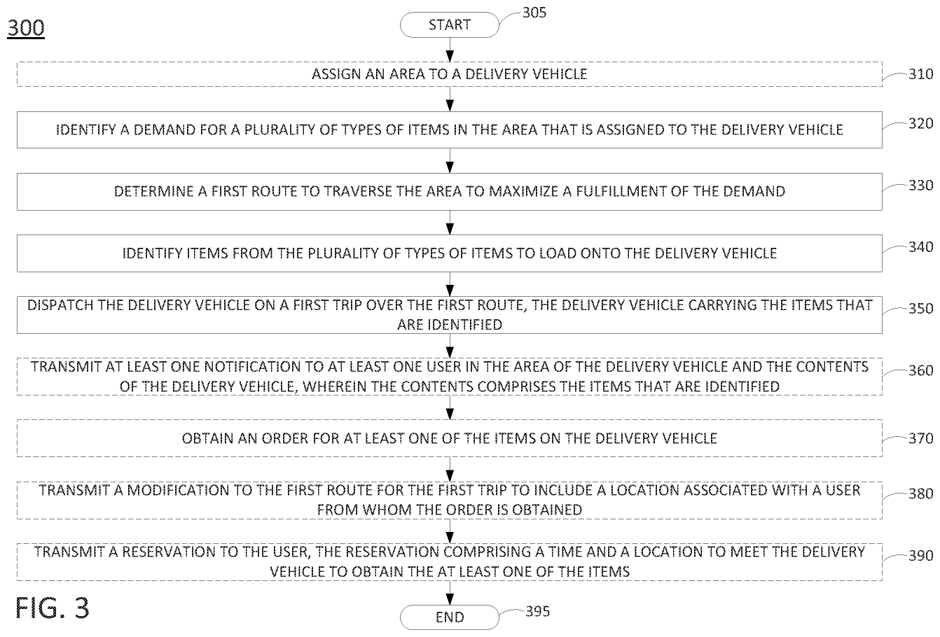

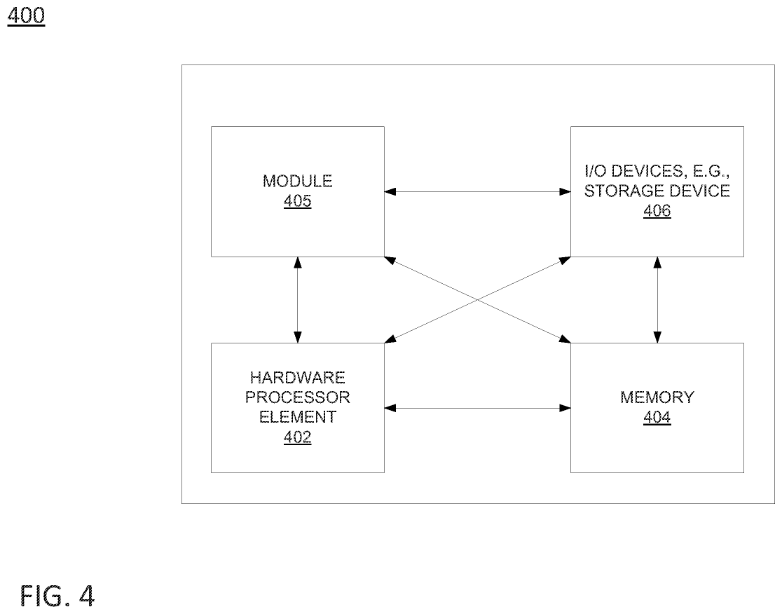

In one example, devices 110 and 112 may comprise a computing device or processing system, such as computing system 400 depicted in FIG. 4, and may be configured to provide one or more operations or functions in connection with examples of the present disclosure for determining a route for dispatching a delivery vehicle on a trip to traverse an area to maximize a fulfillment of a demand for a plurality of types of items in the area. More specifically, a flowchart of an example method 300 for determining a first route for dispatching a delivery vehicle on a first trip to traverse an area to maximize a fulfillment of a demand for a plurality of types of items in the area is illustrated in FIG. 3 and discussed in greater detail below.

In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

Similarly, server(s) 114 may each comprise a computing system or server, such as computing system 400 depicted in FIG. 4, and may be configured to perform operations in connection with examples of the present disclosure for determining a first route for dispatching a delivery vehicle on a first trip to traverse an area to maximize a fulfillment of a demand for a plurality of types of items in the area, e.g., as described in connection with FIG. 3. For instance, server(s) 114 may provide a delivery system (e.g., a “continuous delivery system”) in accordance with the present disclosure. In one example, database(s) 115 may represent one or more distributed file systems, e.g., a Hadoop® Distributed File System (HDFS™) or the like. Server(s) 114 may receive and store information in database(s) 115 relating to different users, such as users 140 and 141. For instance, users 140 and 141 may register with and opt-in to a continuous delivery service provided by server(s) 114. This information may include, user device information (e.g., identifiers of devices 110 and 112), user location information (e.g., determined from GPS location data of devices 110 and 112, or the like), home location information, work location information, shopping lists, wish lists, or the like, past order information (e.g., a purchase history) from the continuous delivery service and/or from various other entities, current order information, account information, such as outstanding balances or credits, billing address, etc., and so on. In one example, server(s) 114 may establish communications with devices 110 and 112 periodically or on another basis to obtain and update all or a subset of the information maintained in database(s) 115 relating to users 140 and 141 (and other users of the continuous delivery service).

Database(s) 115 may also store information regarding a fleet of one or more delivery vehicles, such as delivery vehicle 195. This information may include, for each delivery vehicle, a make, model, year, firmware version, fuel level (e.g., gas or electric), range, current inventory, assigned distribution zone, assigned route, current orders, and so forth. The assigned route may include a sequence of waypoints (e.g., street addresses and/or geographic coordinates) along with target times for reaching or passing the respective waypoints within a delivery area. The current orders may include stopping locations and times, information regarding a user associated with the order, such as device information, digital key information for allowing access to the items in the order, and so forth. Such information may also be transmitted to the delivery vehicles, such as delivery vehicle 195, by server(s) 114. In addition, database(s) 115 may store an inventory of a distribution center, which may be maintained and/or accessed by server(s) 114. The server(s) 114 may select from the inventory of the distribution center when choosing items to load onto a delivery vehicle, such as delivery vehicle 195, for each trip on an assigned route in a delivery area.

In addition, in one example, database(s) 115 may include a geographic information system (GIS). For instance, database(s) 115 may also store and provide one or more road map databases, such as the United States Geological Survey (USGS) National Transportation Dataset (NTD), ArcGIS, HERE map database, and so forth. In one example, database(s) 115 may also provide traffic data (e.g., road traffic) data in addition to other geographic information. For instance, one or more of database(s) 115 may alternatively or additionally provide a traffic data service. In one example, database(s) 115 may store, and/or server(s) 114 may combine or overlay geographic data (e.g., map data) and traffic data from multiple sources, which may be used to determine and assign routes to delivery vehicles for trips through delivery areas. In addition, user location information, and/or or location information associated with past orders may be combined with map data to determine waypoint along a route, delivery locations along or near the route, and so on.

In one example, AS 104 may comprise a network-based server (or servers) providing a delivery system. In this regard, AS 104 may comprise the same or similar components as server(s) 114 and may provide the same or similar functions, or at least a portion thereof. For instance, an operator of network 102 may provide a delivery system via AS 104 in accordance with the present disclosure (e.g., in addition to telecommunication services such as TV, phone, internet access, etc., as described above). Accordingly, DB(s) 106 may be the same as or similar to DB(s) 115 and may store the same or similar information. Thus, although the following examples are described primarily in connection with server(s) 114, it should be understood that the descriptions may equally apply to AS 104.

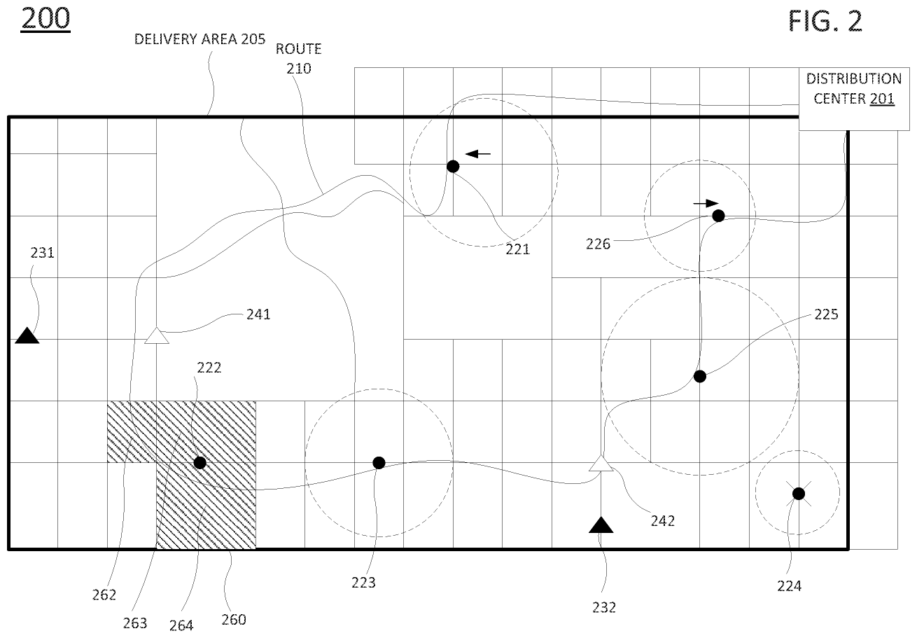

As illustrated in FIG. 1, delivery vehicle 195 may comprise a computing system or server, such as computing system 400 depicted in FIG. 4, and may be configured to perform operations in connection with examples of the present disclosure for determining a first route for dispatching a delivery vehicle on a first trip to traverse an area to maximize a fulfillment of a demand for a plurality of types of items in the area, e.g., as described in connection with FIG. 3, and as further illustrated and described in connection with FIG. 2. In one example, delivery vehicle 195 may include one or more radio frequency (RF) transceivers (as well as antenna(s), and/or other components) for cellular communications and/or for non-cellular wireless communications, such as for IEEE 802.11 based communications, IEEE 802.15 based communications, and so forth. In one example, delivery vehicle 195 may include various additional equipment utilized in autonomous or assisted navigation operations, such as a light detection and ranging (LIDAR) system, a global positioning system (GPS) unit, or the like.

It should be noted that the foregoing is just one illustrative example of how examples of the present disclosure for determining a first route for dispatching a delivery vehicle on a first trip to traverse an area to maximize a fulfillment of a demand for a plurality of types of items in the area may operate. Thus, it should be noted that in other, further, and different examples, aspects described above with respect to server 114 may alternatively or additionally be provided by AS 104. In addition to the foregoing, various other features of the present disclosure may be provided via the system 100. It should also be noted that although the delivery vehicle 195 may comprise an autonomous vehicle, in another example, the delivery vehicle 195 may comprise a human operated vehicle, or a vehicle that is operated with human assistance, but where the inventory, the route(s) for various trips, the stops and/or deliveries to be made, and so forth, is managed by a delivery system (e.g., server(s) 114).

It should also be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. For example, the system 100 may include other network elements (not shown) such as border elements, routers, switches, policy servers, security devices, gateways, a content distribution network (CDN) and the like. For example, portions of network 102 and/or access networks 120 and 122 may comprise a content distribution network (CDN) having ingest servers, edge servers, and the like. Similarly, although only two access networks 120 and 122 are shown, in other examples, access networks 120 and/or 122 may each comprise a plurality of different access networks that may interface with network 102 independently or in a chained manner. For example, server 114 and server 116 may reach network 102 via different access networks, devices 110 and 112 may reach network 102 via different access networks, and so forth. Thus, these and other modifications are all contemplated within the scope of the present disclosure.

To further illustrate aspects of the present disclosure, FIG. 2 depicts an example map 200 of a delivery area 205, with an example delivery route 210 illustrated thereon, in accordance with the present disclosure. In one example, the delivery route 210 may be determined by a continuous delivery system, such as server(s) 114 of FIG. 1. As illustrated in FIG. 2, a delivery area 205 may be defined. The delivery area 205 includes various roads, city blocks, a park, and so forth. Several additional streets are shown outside of and adjacent to the delivery area 205 to illustrate that the delivery area 205 may be just one of several delivery areas that are associated with a distribution center 201. Within the delivery area 205 may be several potential route locations 221-226 (e.g., locations that may be included as waypoints along a route). In one example, potential route locations 221-226 may represent locations of users who are present in delivery area 205 (e.g., users registered with a continuous delivery service, or system). For instance, these may be actual locations of users, e.g., as determined from GPS location information of respective user devices, or the like, locations of the users' homes or other locations associated with the users, e.g., places of business, places of educational study, places of leisure, etc.

In one example, potential route locations 221-226 may represent clusters of users. For instance, locations of users may be determined, and the users may be grouped into clusters according to a clustering algorithm. The clustering may result in hard clusters or soft clusters, and so forth. In one example, a potential route location may comprise a centroid of a cluster. Alternatively, a potential route location may be another location within a region around a cluster centroid that is selected to be close to the cluster centroid, but which may be a more ideal location in terms of traffic, parking availability, open space, and/or other factors. For instance, a cluster centroid defined at a certain level of precision may be in the center of a city block, which may not be physically reachable by a delivery vehicle. Thus, a potential route location associated with such a cluster may be moved to an actual street location, a parking lot, or other locations accessible to a delivery vehicle. Similarly, a potential route location may be shifted to a different portion of the street, another street nearby, and so forth. For instance, in the example of FIG. 2, potential route locations 221 and 226 may be shifted from actual cluster centroids based on one or several of the abovementioned factors. In one example, the clustering may be weighted such that locations of users having placed larger orders or more orders (e.g., orders of greater total value in a given look-back time period) are more impactful in defining locations of cluster centroid, or locations of users having more recent orders are more impactful in defining the locations of the cluster centroids, and so forth. In one example, the value of prior orders from each user may be time weighted, e.g., a time weighted moving average, or the like. In one example, the clustering may be weighted such that locations of users having a greater value of items in an online shopping cart are more impactful in defining the location of cluster centroids.

In another example, potential route locations 221-226 may represent locations in delivery area 205 associated with prior orders (e.g., via the continuous delivery service and/or orders made with other entities for which information has been made accessible to the continuous delivery service). The potential route locations 221-226 may be the locations from which prior orders were received (e.g., within a look-back time period, such as within the last 72 hours, the last week, the last two weeks, etc.). In one example, the potential route locations 221-226 may be associated with clusters of prior orders. For instance, the locations of the prior orders may be geographically clustered, and the potential route locations 221-226 may be selected based upon the cluster centroids (e.g., comprising actual cluster centroids, or selected near the cluster centroids but having improved locations with respect to one or more of: traffic, parking, open space, and so forth). The clustering may be the same or similar as described above. In one example, the clustering may be weighted such that larger orders (e.g., orders of greater total value) are more impactful in defining locations of cluster centroid, more recent orders are more impactful in defining the locations of the cluster centroids (such as according to a time-weighted moving average), and so forth.

In one example, a maximum distance for clustering can be set based upon an operator's determination of a reasonable walking distance. In addition, the continuous delivery system may apply a maximum cluster size (in terms of the number of users or number of prior orders being used to determine the cluster(s)) so that in crowded urban areas, instead of one giant cluster, there may instead be several large clusters. Thus, users may be better served by having closer pickup/meeting locations for the delivery vehicle. For instance, even for a giant cluster, the walking distance for any user in a location associated with the cluster to anywhere within a radius of the cluster would be reasonable. Nevertheless, there may be only a small cost to move the delivery vehicle to make three stops, and it may still be more convenient to reduce the overall walking distances of users.

In another example, potential route locations 221-226, may be associated with zones in the delivery area 205. For instance, the delivery area 205 may be divided into equal size zones, e.g., squares, hexagons, or the like to cover the entire delivery area 205. Then locations of prior orders or current locations of users may be assigned to the zones. Demand values indicative of a level of demand for items that may be available from the distribution center 201 may then be calculated for each zone. The demand values may be aggregated from the demand profiles of users located within each zone. For instance, a demand profile may include or comprise a score indicating a level of demand of the particular user, which may be based upon a number of past orders, the magnitude(s) of the past order(s), a number and or value of items on a user's shopping list, and so forth. Alternatively, or in addition, the demand value for each zone may be based upon a total value of prior orders received from within the zone in a given look-back time period, a time-weighted average of prior orders received from within the zone, etc. In one example, the demand values may be specific to a particular time of day and/or day of the week. For instance, orders and order locations may be tracked for particular times of the day such that the aggregate demand value for a zone or cluster may be higher or lower depending upon the time of day. For example, a zone or cluster centered on a portion of the delivery area 205 that is predominantly frequented by office workers may have a higher demand value at lunch time versus a part of the delivery area 205 that is primarily residential, which may have a relatively higher demand value after 7:00 PM.

In one example, zones having a demand value less than a threshold level of demand may be merged with one or more nearby zones. For instance, two adjacent zones having less than a threshold level of demand may be selected to merge. Alternatively, or in addition, a zone having less than the threshold level of demand may be merged with an adjacent zone having more than the threshold level of demand. The dynamically merged zone may have a demand value equal to the sum of demand values of the zones from which the merged zone was created. Candidate route locations (e.g., any one or more of candidate route locations 221-226) may then be selected from within any zones remaining after such merging. In particular, candidate route location 222 is illustrated as being a relatively central location within a merged zone 260 (e.g., created from original zones 262-264) indicated by the shaded area. It should be noted that clusters as discussed above may be similarly assigned a demand value based upon demand profiles of users defining the respective clusters and/or the values of prior orders defining the respective clusters. In any case, the potential route locations 221-226 may inherit the demand values of the clusters or zones to which the potential route locations 221-226 are respectively associated.

The continuous delivery system may then define the route 210 using one or more of the potential route locations 221-226 as waypoints along the route 210. In one example, the route 210 may be selected in accordance with a route optimization algorithm (e.g., an algorithm for a solution to a vehicle routing problem, or a vehicle routing problem (VRP) algorithm). In one example, the route optimization algorithm may include at least one capacity constraint and at least one penalty factor. For instance, the at least one capacity constraint may comprise a fuel limit associated with a delivery vehicle being assigned to the delivery area 205 (and to the route 210), a distance limit for the route 210, or the like. The penalty factor may comprise a penalty for omitting a potential route location from the first route, the penalty associated with a level of demand associated with the potential route location. Notably, the penalty factor may help to eliminate potential route locations from the route 210 which are too far out of the way and/or of lower demand such that the route 210 traverses through locations that are more optimal for maximizing the fulfillment of demand for items within the delivery area 205 per unit time.

A delivery vehicle may then be loaded with items available from the inventory of the distribution center 201 and dispatched on a trip in the delivery area 205 on the route 210. The particular items that are loaded may be selected by identifying values for each type of item that is in demand based upon demand levels for particular items associated with route locations along the first route. For instance, user demand profiles may include a score or demand level for individual types of items that may be available from distribution center 201. Similarly, the continuous delivery system may maintain per-item demand levels for individual types of items calculated from prior orders from within each cluster or zone. The demand levels may comprise or may be scaled so that a predicted demand per item over the expected time that an assigned delivery vehicle will be traversing the route 210 is quantified in terms of a number of the items (e.g., the predicted demands for several items at a particular route location (e.g., for a cluster or zone) may be for 10 rolls of paper towels, 30 gallons of milk, 5 liters of orange juice, 4 packs of batteries, and so forth). The continuous delivery system may add the predicted demands for individual items associated with each location (e.g., 221, 222, 223, 225, and 226) along the route 210 to determine the overall predicted demands for individual items along the entire route 210.

Next, the continuous delivery system may assign the items to load onto the delivery vehicle in an order based upon the values for each type of item and the quantities of the predicted demands. For instance, all items of higher relative value may be assigned to load before items of lower value (e.g., up to the predicted number of the higher valued items to be in demand, or in one example, a few more than predicted). In addition, the assigning of the items may be stopped when a capacity of the delivery vehicle is reached. The delivery vehicle may then be dispatched on a trip along the route 210, e.g., traversing from the distribution center 201 to 221, 222, 223, 225, 226, and back to the distribution center 201. In one example, an expected time to complete the route 210 may be calculated based upon an average time to complete past trips over the same route 210 or over different routes of different lengths within the delivery area 205, a weighted average, etc. In addition, in one example, an expected time to complete the route 210 may include time allowances for a predicted number of stops (e.g., to fulfill orders), which may be similarly calculated from averages of past trips, etc. Alternatively, expected times for stops may be included in the overall calculation of the expected time to complete a trip over the route 210.

Notably, the delivery vehicle does not have prior orders that it is expected to fulfill. Rather, as noted above, orders may be received from users in the delivery area 205 (either directly by the delivery vehicle from the user's computing devices, or via the continuous delivery system) as the delivery vehicle is already navigating the route 210. In some cases, orders may be received from users located directly along the route 210. Accordingly, the delivery vehicle may find safe and appropriate places to stop along the route at or near the user's locations. However, in other cases, orders may be received from users who are not located along the route 210. In these cases, the delivery vehicle and/or the continuous delivery system may make a determination of whether a deviation from the route 210 is permitted to be made to accommodate delivering items directly to a user's location, or whether the user should be instructed to meet the delivery vehicle somewhere along the route 210. To illustrate, a user at location 231 may place an order for one or more items. The delivery vehicle and/or the continuous delivery system may then determine that the user is too far off of the route 210. Accordingly, the user may be instructed to meet the delivery vehicle at location 241, which is the closest point along the route 210 to the user's location 231. Similarly, a user at location 232 may place an order for one or more items. The delivery vehicle and/or the continuous delivery system may then determine that the user is too far off of the route 210. Accordingly, the user may be instructed to meet the delivery vehicle at location 242, which is the closest point along the route 210 to the user's location 232. However, in another instance, the delivery vehicle and/or the continuous delivery system may then determine that the user is not too far off of the route 210. In other words, the delivery vehicle may be permitted to deviate from the route 210 to deliver more directly to the user at the user's location 232, and then after the delivery stop, may return to the route 210 at or near where the route 210 was left, or at a point along route 210 that puts the delivery vehicle closer to a next waypoint (e.g., 225). The determination of whether the user is “too far” off of the route 210 (or sufficiently close to accommodate a deviation) may be based upon the distance between the user and one or more points along the route 210 closest to the user's location, an anticipated time off of route (e.g., to account for traffic or other conditions in addition to the distance), a number of other orders already received and not yet fulfilled (e.g., for users having already placed orders, and who are further along the route 210), and so on. In one example, a maximum distance or time of deviation may be set as a condition such that the delivery vehicle may be permitted to deviate no more than a half mile from the route 210, no more than 5 minutes off the route 210, etc.

However, it should be noted that when such orders are received, the locations of the orders, and the users placing such orders may be recorded, and this information may be used for calculating a route through the delivery area 205 for subsequent trips. Thus, over time, if users continue to place orders from locations 231 and 232, the cluster centroids may dynamically move such that potential route locations may be closer to these locations 231 and 232, existing clusters may be split into two clusters, which may have centroids closer to locations 231 and 232, merged zones resulting in the determination of route 210 may instead remain as the original zones (e.g., the original zones having demand levels that are recalculated to exceed a demand threshold such that the original zones are not merged with or into another zone, or zones, etc.), and so on.

It should also be noted that in one example, the route 210 may be such that the delivery vehicle assigned to the route through the delivery area 205 may complete multiple passes over the route 210 during the course of a single trip (e.g., on a single tank of fuel and/or charge of battery). In such case, the continuous delivery system may adjust a portion of the route 210 to eliminate the distribution center as a stop. For instance, the route 210 may be adjusted to fit a path more directly between locations 226 and 221. In another example, location 224 can be dynamically dropped from the route 210, e.g., no demand for any item on the delivery vehicle is registered for that location, items predicted for that location have all been sold earlier in the route and so on. In addition, it should be noted that FIG. 2 illustrates a representative route 210 in a delivery area 205, and that in other, further, and different examples, a delivery area may have a different size and dimensions, may be associated with more than one distribution center, may have multiple delivery vehicles operating therein simultaneously over the same route or different routes, and so forth. Thus, these and other modifications are all contemplated within the scope of the present disclosure.

FIG. 3 illustrates a flowchart of an example method 300 for determining a first route for dispatching a delivery vehicle on a first trip to traverse an area to maximize a fulfillment of a demand for a plurality of types of items in the area. In one example, the method 300 is performed by one or more servers of a continuous delivery system, or service, such as server(s) 114 or AS 104 of FIG. 1, or any one or more components thereof, or by any one or more of such servers or devices in conjunction with one another and/or in conjunction with other devices and/or components of system 100 of FIG. 1. In one example, the steps, functions, or operations of method 300 may be performed by a computing device or processing system, such as computing system 400 and/or hardware processor element 402 as described in connection with FIG. 4 below. For instance, the computing system 400 may represent any one or more components of the system 100 that is/are configured to perform the steps, functions and/or operations of the method 300. Similarly, in one example, the steps, functions, or operations of the method 300 may be performed by a processing system comprising one or more computing devices collectively configured to perform various steps, functions, and/or operations of the method 300. For instance, multiple instances of the computing system 400 may collectively function as a processing system. For illustrative purposes, the method 300 is described in greater detail below in connection with an example performed by a processing system. The method 300 begins in step 305 and may proceed to optional step 310 or to step 320.

At optional step 310, the processing system may assign an area to a delivery vehicle, e.g., a delivery area. In one example, a processing system may assign the area to the delivery vehicle in accordance with an operator selection of one or more area (e.g., delivery/distribution areas associated with a distribution center). In one example, this may be based upon the number of available delivery vehicles, the total number of users in and around the area (e.g., in the area, and in adjacent areas), and so on. In one example, the area may be determined for a particular time of day or day of the week. For example, during overnight hours, an operator may determine to conserved resources and dispatch only one delivery vehicle for every four that may be operated during daytime hours. Thus, four different areas during daytime hours may comprise a single area for the overnight hours.

At step 320, the processing system identifies a demand for a plurality of types of items in the area that is assigned to the delivery vehicle. For instance, the demand for the plurality of types of items may be based upon a plurality of prior orders include the plurality of types of item. In one example, the plurality of prior orders may have been received from users located within the area at the times of placing the respective prior orders. In another example, the plurality of prior orders may have been received from users currently located within the area (at the time of performing step 320), where the orders may or may not have been placed from within the area. For instance, the demand for the plurality of types of items in the area may be determined from demand profiles of users who are currently located in the area (the demand profiles characterizing each user's level of demand for various items based upon the user's prior orders). In some cases, the demand for the plurality of types of items in the area may be further based upon information indicating an interest of users in the area in the plurality of types of items (e.g., shopping list information, wish list information, information on user orders for various items from other entities, a brand new item being introduced into the market (e.g., a new soft drink, a new snack, a new book, a new apparel, etc.), or the like).

In one example, step 320 may include assigning demand values to zones within the area based upon demand profiles of the users and user locations of the users within the zones, or based upon prior orders that include the plurality of types of items associated with each of the zones. In such an example, step 320 may further include, for each zone in the plurality of zones having a demand value less than a threshold level of demand, merging the zone with at least one other zone of the plurality of zones. In addition, representative locations within each of the plurality of zones remaining after the merging may comprise a plurality of potential route locations. In another example, step 320 may include assigning demand values to potential route locations within the area based upon demand profiles of the users and user locations of the users, or based upon prior orders including the plurality of types of items associated with each of the potential route locations. For instance, the potential route locations may be associated with cluster centroids of at least one of: locations from which past orders were received within the area, or user locations of users in the area. As noted above, the clusters may be formed via hard or soft clustering based upon locations of past orders or current user locations, and in one example, weighted by level of demand of respective users or values/quantities of items contained in past orders.

The potential route locations may comprise representative locations in relatively central locations within each zone, or at or near cluster centroids, where the processing system may make adjustments to avoid poor location choices, such as avoiding highways, avoiding streets with high speed limits, narrow one way streets, no parking zones, etc., or to favor public parks, wide uncrowded streets, streets that are predominantly commercial or residential, etc. In one example, the adjustments can be determined from information extracted and analyzed from map data (and or traffic data, which may be part of or separate from the map data). In one example, representative locations may be located in parts of zones with the greatest concentration of users, greatest concentration of past orders, or combination of both, (if such data is tracked with users' consent and available and/or of a zone is large enough that orders or users can be associated with sub-locations within the zone).

At step 330, the processing system determines a first route to traverse the area to maximize a fulfillment of the demand. For instance, the first route may be selected in accordance with a route optimization algorithm (e.g., an algorithm for a solution to a vehicle routing problem, or a vehicle routing problem (VRP) algorithm). In one example, the first route may comprise waypoints selected from among potential route locations identified at step 320. In other words, the first route is selected to include at least a portion of the plurality of potential route locations. For instance, each potential route location may comprise a stop that may be accommodated into a route comprising a solution via the VRP algorithm. In one example, the route optimization algorithm may include at least one capacity constraint and at least one penalty factor. For instance, the at least one capacity constraint may comprise a fuel limit associated with a delivery vehicle being assigned to the area (and the first route), a distance limit for the first route, or the like. The penalty factor may comprise a penalty for omitting a potential route location from the first route, the penalty associated with a level of demand associated with the potential route location. For instance, the penalty may be equal to the demand associated with the potential route location, or may be scaled by a scaling factor. As such, the VRP algorithm may permit dropped “nodes” or dropped stops. Thus, not all of the potential route locations may be included in the route solution.

At step 340, the processing system identifies items from the plurality of types of items to load onto the delivery vehicle. In one example, step 340 may include identifying values for each type of item that is in demand based upon demand profiles of users associated with route locations along the first route. In addition, step 340 may include assigning the items to load onto the delivery vehicle in an order based upon the values for each type of item, where items of higher value are assigned to load before items of lower value, and where the assigning of the items is stopped when a capacity of the delivery vehicle is reached. In one example, the values/demands for different items can also be scaled to account for differences in capacity of the delivery vehicle. For instance, $10.00 for a 12 pack of paper towels may be scaled down because the same volume could be occupied by hundreds of AA batteries worth several hundred dollars, the same volume could be occupied by 12 loaves of bread worth $3.00 each for a total of $30, and so on.

At step 350, the processing system dispatches the delivery vehicle on a first trip over the first route, the delivery vehicle carrying the items that are identified. In one example, the delivery vehicle may be instructed to continue along the route (e.g., multiple loops) for as long as the delivery vehicle is capable on a given charge or tank of gas, within a designated time block (e.g., within a two hour time period, a four hour time period, etc.), and so on.

At optional step 360, the processing system may transmit at least one notification to at least one user in the area of the delivery vehicle and the contents of the delivery vehicle, wherein the contents comprises the items that are identified. The at least one notification may further include information associated with the first route, such as a map with anticipated times for the delivery vehicle to be at anticipated locations in the area. For instance, the at least one notification may be transmitted to mobile devices of various users from the processing system over one or more networks, and/or via the delivery vehicle (e.g., using peer-to-peer and/or other wireless communications between the delivery vehicle and user devices within the area for the last-hop of the notification(s) sent by the processing system).

At optional step 370, the processing system may obtain an order for at least one of the items on the delivery vehicle. In one example, the demand for the plurality of types of items in the area may also be updated in accordance with the order (e.g., for calculating a route for subsequent trips in the area, for determining the items to load onto the same or a different delivery vehicle for such subsequent trips, and so forth). For instance, a second route for a second trip of the delivery vehicle after the first trip may be selected to traverse the area to maximize a fulfillment of the demand based upon a plurality of orders, the plurality of orders including the order. In one example, the order may be obtained via the delivery vehicle from a user, which may be passed to the processing system.

At optional step 380, the processing system may transmit a modification to the first route for the first trip to include a location associated with a user from whom the order is obtained. For instance, the processing system may determine that the location associated with the user is within a maximum deviation that will be allowed before instructing user that the user must instead meet the delivery vehicle. Alternatively, or in addition, the processing system may determine that the location associated with the user may be accommodated based upon one or more of a distance off the first route to the location, an anticipated time off the first route, a number of additional orders from within the area previously received but not yet fulfilled, and so forth.

At optional step 390, the processing system may transmit a reservation to the user, the reservation comprising a time and a location to meet the delivery vehicle to obtain the at least one of the items. The location may be the user's location, or may be a different location, such as a point along the first route that is closest to the user's location.

Following step 350, or any of optional steps 360-390, the method 300 proceeds to step 395. At step 395 the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 320-350 for subsequent trips in the area, steps 310-350 for different areas associated with a same distribution center or different distribution centers, and so on. In one example, the method 300 may be expanded to include adjusting a boundary of the area (which may involve similarly adjusting a boundary or boundaries of one or more adjacent areas).

In another example, the method 300 may include setting an initial route for the area to cover as much of the area as possible in one trip without refueling. In one example, highways may be omitted except when it is a best route to get from one part of the area to another. In one example, population density may be taken into account to favor more densely populated parts of the area. In one example, the population density can change from one time of day to another and from day to day, weekday to weekend, etc. In one example, the population distribution, or density in different parts of the area (e.g., in different zones, or the like) may be determined based upon map metadata or satellite image analysis to identify single family residences, multi-family units, apartment buildings, office buildings, commercial facilities, and so forth. Similarly, the population distribution, or density in different parts of the area can be based upon aggregated, non-personally identifiable mobile device location information indicating density by block or other sub-units within an area. The routing algorithm may then favor more densely populated locations. This can adapt to plan a route based upon the distribution of mobile devices at the time of dispatch of the delivery vehicle and/or in anticipation of the distribution at some time following dispatch, e.g., within the next hour, next two hours, etc. The initial route, or initial routes for different times of day, different days of the week, etc., may then be dynamically updated by the processing system via subsequent iterations of the method 300 to learn and adapt to user demand profiles and/or the locations of orders received from within the area, and so on.

In one example, the method 300 may be modified to determine two or more routes for two or more vehicles in an area simultaneously, where routes and loaded items can be jointly optimized to maximize the fulfillment of the demand in the area (e.g., to move the most amount of items or greatest value in items to users within the area). For instance, one part of the area may prefer certain types of items while another part of area may like other types of items for a particular time of day, day of week, etc. (e.g., a residential zone of the area vs. a commercial zone of the area). However, it is not necessarily the case that the processing system will simply divide the area into two sub-areas for the two delivery vehicles along these general lines (e.g., via the route optimization algorithm applied at step 330). For instance, if a residential zone results in relatively less orders, a delivery vehicle with a route allotted more time/distance in the residential zone of the area may still have a portion of the route that extends into the commercial zone and may carry items that may be appealing to users in the commercial zone that are not as popular as items carried on the other delivery vehicle but which may help achieve an overall optimization criterion of maximizing orders in the area in the given time period.

In one example, step 330 may include applying additional constraints to the route selection (e.g., non-optimization factors, which may comprise “fairness criteria”). For instance, an operator of a continuous delivery system may bias the route optimization algorithm to select routes that follow a reverse order for different trips, different days, different weeks, etc., so that certain parts of area are not always favored over others. For instance, the algorithm may be assigned a fixed first waypoint that was a last waypoint for a prior route, and so forth. In one example, the operator may configure the route optimization algorithm to select a sequence of different routes, such as a sequences of three routes which collectively cover parts of a zone, e.g., over the course of 4 hours, a half day, etc. The routes may not necessarily be non-overlapping, or non-repeating. For example, busy locations which generate many orders may be included in all of the routes and passed at least once each trip, whereas some less busy parts of the area may be directly serviced, but perhaps only on one of the three routes (e.g., once in the 4 hour period, half-day period, etc.). Accordingly, a user may be willing to walk a quarter mile to meet a delivery vehicle on its route for a particular trip, or may wait a few hours until the delivery vehicle passes the user's location directly on a different trip taking a different route. Thus, these and other modifications are all contemplated within the scope of the present disclosure.

In addition, although not expressly specified above, one or more steps of the method 300 may include a storing, displaying and/or outputting step as required for a particular application. In other words, any data, records, fields, and/or intermediate results discussed in the respective methods can be stored, displayed and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components or devices illustrated in FIG. 1, or described in connection with FIG. 2 or FIG. 3, may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for determining a first route for dispatching a delivery vehicle on a first trip to traverse an area to maximize a fulfillment of a demand for a plurality of types of items in the area, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for determining a first route for dispatching a delivery vehicle on a first trip to traverse an area to maximize a fulfillment of a demand for a plurality of types of items in the area (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for determining a first route for dispatching a delivery vehicle on a first trip to traverse an area to maximize a fulfillment of a demand for a plurality of types of items in the area (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
identifying, by a processing system including at least one processor, a demand for a plurality of types of items in an area that is assigned to a delivery vehicle;
determining, by the processing system, a first route to traverse the area to maximize a fulfillment of the demand;
identifying, by the processing system, items from the plurality of types of items to load onto the delivery vehicle; and
dispatching, by the processing system, the delivery vehicle on a first trip over the first route, the delivery vehicle carrying the items that are identified.

2. The method of claim 1, further comprising:
assigning the area to the delivery vehicle.

3. The method of claim 1, further comprising:
transmitting at least one notification to at least one user in the area of the delivery vehicle and contents of the delivery vehicle, wherein the contents comprises the items that are identified.

4. The method of claim 3, wherein the at least one notification further includes a plurality of anticipated times for the delivery vehicle to be at a plurality of anticipated locations in the area.

5. The method of claim 1, further comprising:
obtaining an order for at least one of the items on the delivery vehicle.

6. The method of claim 5, further comprising:
transmitting a modification to the first route for the first trip to include a location associated with a user from whom the order is obtained.

7. The method of claim 5, further comprising:
transmitting a reservation to the user, the reservation comprising a time and a location to meet the delivery vehicle to obtain the at least one of the items.

8. The method of claim 6, wherein the demand for the plurality of types of items in the area is updated in accordance with the order, wherein a second route for a second trip of the delivery vehicle after the first trip is selected to traverse the area to maximize a fulfillment of the demand based upon a plurality of orders, the plurality of orders including the order.

9. The method of claim 1, wherein the demand for the plurality of types of items is based upon a plurality of prior orders including the plurality of types of items.

10. The method of claim 1, wherein the identifying the demand for the plurality of types of items in the area comprises:
assigning demand values to zones within the area based upon:
demand profiles of users and user locations of the users within the zones; or
prior orders that include the plurality of types of items associated with each of the zones.

11. The method of claim 10, wherein the identifying the demand for the plurality of types of items in the area further comprises:
for each zone in the plurality of zones having a demand value less than a threshold level of demand, merging the zone with at least one other zone of the plurality of zones, wherein representative locations within the plurality of zones remaining after the merging comprises a plurality of potential route locations, wherein the first route is selected to include at least a portion of the plurality of potential route locations.

12. The method of claim 1, wherein the identifying the demand for the plurality of types of items in the area comprises:
assigning demand values to potential route locations within the area based upon:
demand profiles of users and user locations of the users; or
prior orders including the plurality of types of items associated with each of the potential route locations.

13. The method of claim 12, wherein the potential route locations are associated with cluster centroids of at least one of:
locations from which the prior orders were received within the area; or
the user locations of the users in the area.

14. The method of claim 1, wherein the first route is selected in accordance with a route optimization algorithm.

15. The method of claim 14, wherein the route optimization algorithm includes at least one capacity constraint and at least one penalty factor.

16. The method of claim 15, wherein the at least one capacity constraint comprises at least one of:
a fuel limit; or
a route distance limit.

17. The method of claim 15, wherein the at least one penalty factor comprises a penalty for omitting a potential route location from the first route, the penalty associated with a level of demand associated with the potential route location.

18. The method of claim 1, wherein the identifying the items from the plurality of types of items to load onto the delivery vehicle comprises:
identifying values for each type of item that is in demand based upon demand profiles associated with route locations along the first route; and
assigning the items to load onto the delivery vehicle in an order based upon the value for each type of item, wherein items of higher value are assigned to load before items of lower value, and wherein the assigning of the items is stopped when a capacity of the delivery vehicle is reached.

19. A non-transitory computer-readable medium storing instructions that, when executed by a processing system including at least one processor, cause the processing system to perform operations, the operations comprising:
identifying a demand for a plurality of types of items in an area that is assigned to a delivery vehicle;
determining a first route to traverse the area to maximize a fulfillment of the demand;
identifying items from the plurality of types of items to load onto the delivery vehicle; and
dispatching the delivery vehicle on a first trip over the first route, the delivery vehicle carrying the items that are identified.

20. An apparatus comprising:
a processing system including at least one processor; and
a non-transitory computer-readable medium storing instruction that, when executed by the processing system, cause the processing system to perform operations, the operations comprising:
identifying a demand for a plurality of types of items in an area that is assigned to a delivery vehicle;
determining a first route to traverse the area to maximize a fulfillment of the demand;
identifying items from the plurality of types of items to load onto the delivery vehicle; and
dispatching the delivery vehicle on a first trip over the first route, the delivery vehicle carrying the items that are identified.
